(19) United States
(12) Patent Application Publication
(10) Pub. No.: US 2006/0049934 A1
(43) Pub. Date: Mar. 9, 2006

(54) Methods and systems for utilizing a data network for the communication of emergency alerts

(75) Inventor: Thomas Breen, Snellville, GA (US)

Correspondence Address: Merchant & Gould P.C., P.O. Box 2903, Minneapolis, MN, 55402-0903, US

(73) Assignee: BellSouth Intellectual Property Corporation

(21) Appl. No.: 10/935,491

(22) Filed: Sep. 7, 2004

(51) Int. Cl. G08B 1/00; G08B 23/00

(52) U.S. Cl. 340/531; 340/500

(57) ABSTRACT

A method and system are provided for utilizing a data network for the communication of emergency alerts. A monitoring station generates a data message containing an emergency alert which is communicated to alert nodes over the data network. Each alert node communicates the emergency alert in the data message to a communications device such as a telephone or a wireless device. Each alert node may be in communication with a subscriber database for communicating the emergency alert to subscribers in the subscriber database. A text message generator may be utilized to generate a text message including the emergency alert for communication to a compatible caller identification device. The alert node may also prioritize the communication of the emergency alert in the data message over other voice and data traffic.

### TECHNICAL FIELD

The present invention relates to emergency alert systems. More particularly, the present invention is related to utilizing a data network for the communication of emergency alerts.

### BACKGROUND OF THE INVENTION

Emergency alert systems are deployed in a number of communities to alert large numbers of persons of an impending or ongoing emergency. Current systems utilize a variety of methods for communicating alerts including the use of external alerts, such as sirens, and using the public switched telephone network (“PSTN”) to automatically initiate large numbers of telephone calls to persons by an emergency. Typically, telephone alert systems include the communication of emergency information from a public service answering point (“PSAP”) which initiates the telephone calls over standard telephone lines to one or more destination switches in the PSTN. Both methods, however, include a number of drawbacks.

Problems associated with external alert systems, such as sirens, include the cost of deployment and the lack of effectiveness for people inside buildings where the sirens may be difficult to hear. Similarly, current telephone alert systems lack effectiveness due to the possibility of a large number of telephone calls going to a single destination switch in the PSTN causing a network overload. In this scenario, the destination switch, which may also be carrying normal call traffic to subscribers in the PSTN, is inundated with a large number of emergency calls resulting in the emergency call traffic being blocked or unreasonably delayed due to congestion.

### SUMMARY OF THE INVENTION

In accordance with the present invention, the above and other problems are addressed by methods and systems for utilizing a data network for communicating emergency alerts. By utilizing the data network, congestion caused by the communication of large numbers of emergency telephone calls over the PSTN is relieved, resulting in a reliable and efficient method of alerting persons in a given geographic area of critical events.

According to one embodiment of the invention, a method is provided for utilizing a data network for the communication of emergency alerts. The method includes generating a data message comprising an emergency alert, determining an alert node for communicating the data message, and communicating the data message over the data network to the alert node. The data message may include an Internet protocol (“IP”) message. The alert node may include a central office switch or a mobile switching center. The method may further include accessing a subscriber database at the alert node and communicating the emergency alert in the data message from the alert node to subscribers in the subscriber database. The emergency alert may be communicated from the alert node to the subscribers as a plain old telephone system (POTS) signal to a telephone or a cellular network compatible signal, such as a Short Message Service (SMS) message to a wireless device. The POTS signal may include a text message compatible with a caller identification device such that the subscriber does not have to pick up the telephone to receive the message.

According to another embodiment of the invention, a system is provided for utilizing a data network for the communication of emergency alerts. The system includes a monitoring station for generating a data message comprising an emergency alert and alert nodes for receiving the data message from the monitoring station over the data network and communicating the emergency alert in the data message to a communications device such as a POTS telephone or a wireless device. Each alert node is in communication with a subscriber database and an autodialer for communicating the emergency alert to subscribers in the subscriber database. The system may also include a text message generator for generating a text message compatible with a caller identification device. The alert node is further operative to prioritize the communication of the emergency alert in the data message.

These and various other features, as well as advantages, which characterize the illustrative embodiments of the present invention, will be apparent from a reading of the following detailed description and a review of the associated drawings.

### BRIEF DESCRIPTION OF THE DRAWINGS

FIG. 1 is a network diagram illustrating aspects of a network architecture utilized in the various illustrative embodiments of the invention;

FIG. 2 is a block diagram illustrating aspects of a monitoring station in the network architecture of FIG. 1, utilized in and provided by the various illustrative embodiments of the invention;

FIG. 3 is a block diagram illustrating aspects of a central office in the network architecture of FIG. 1, utilized in and provided by the various illustrative embodiments of the invention;

FIG. 4 is a flow diagram illustrating aspects of a process for utilizing a data network described in the network architecture of FIG. 1, according to one illustrative embodiment of the invention.

### DETAILED DESCRIPTION OF THE INVENTION

In accordance with illustrative embodiments of the present invention, the above and other problems are addressed by methods and systems for utilizing a data network for communicating emergency alerts. By utilizing the data network, congestion caused by the communication of large numbers of emergency telephone calls over the PSTN is relieved, resulting in a reliable and efficient method of alerting persons in a given geographic area of critical events.

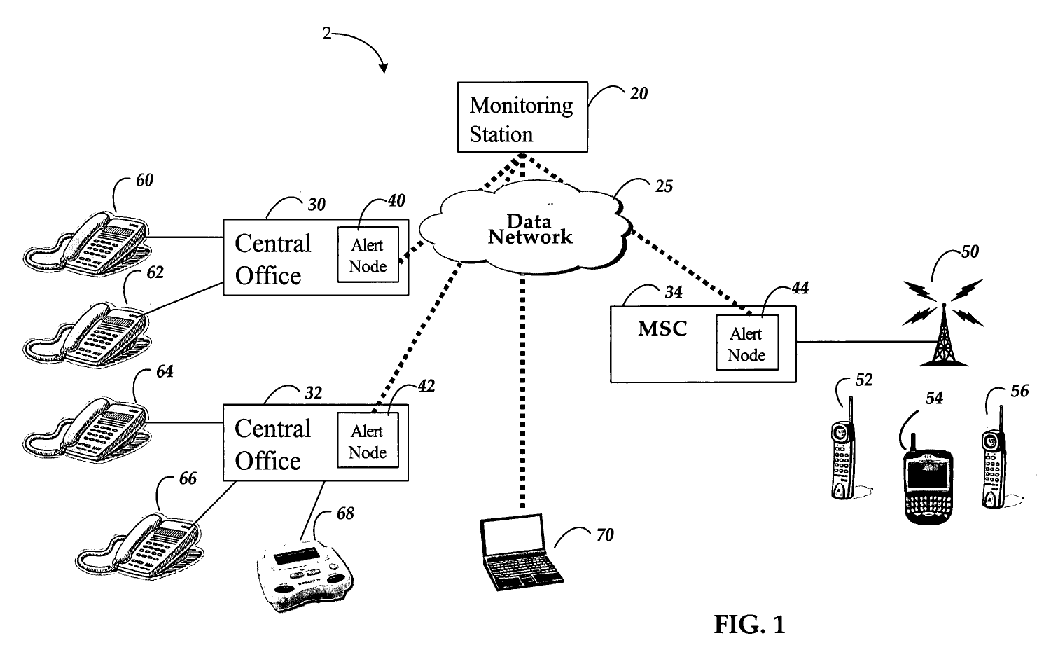

Referring now to the drawings, in which like numerals represent like elements, various aspects of the present invention will be described. In particular, FIG. 1 and the corresponding discussion are intended to provide a brief, general description of a suitable communications network environment in which embodiments of the invention may be implemented.

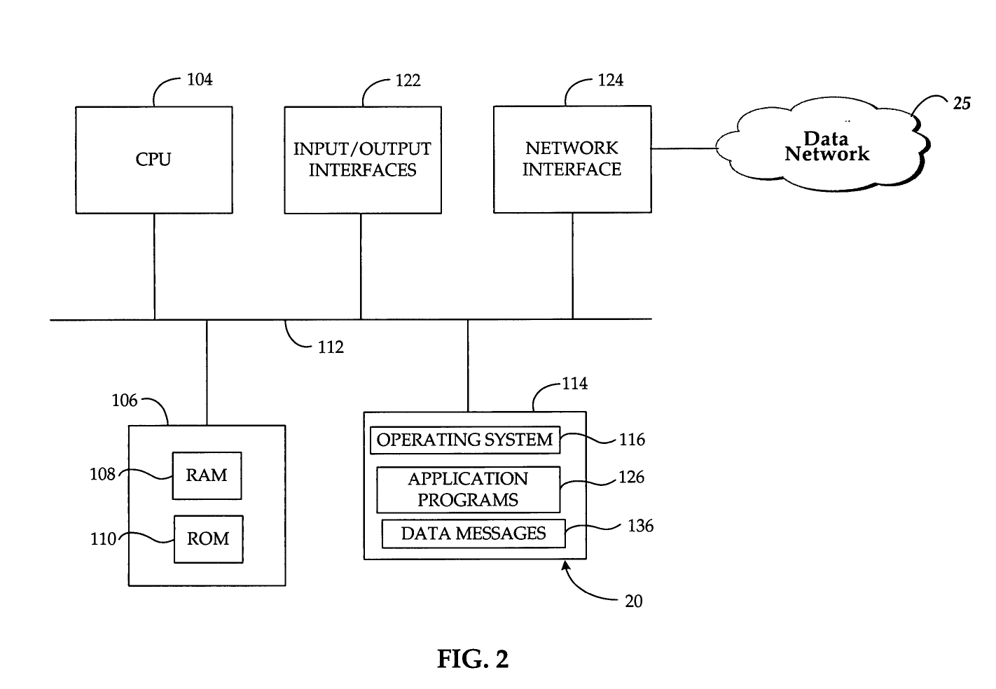

Referring now to FIG. 1, an illustrative network architecture for performing various illustrative embodiments of the invention will be described. As shown in FIG. 1, a communications network 2 includes a monitoring station 20, central offices 30 and 32, a mobile switching center (“MSC”) 34, and a personal computer 70, all of which are in communication with a data network 25. In the communications network 2, the monitoring station 20 is utilized to generate and communicate data messages containing emergency alerts over the data network 25. The monitoring station 20 may be a PSAP for receiving and routing emergency alerts in the communications network 2. It will be appreciated by those skilled in the art that the monitoring station 20 is not limited to a PSAP but may also be any entity charged with identifying situations that the public should be alerted to. These entities may include semi-automated or automated systems requiring little or no human intervention. For example, an entity could automatically initiate an alert sequence to a predefined group of recipients, which in turn may initiate specific alerts to the general public utilizing illustrative embodiments of the invention. The monitoring station 20 could also be representative of a commercial (i.e., non-emergency) entity for communicating a messages using the data network 25 to a defined group of recipients. For example, a telecommunications company utilizing various illustrative embodiments of the invention may broadcast sales or service information to customers. The monitoring station 20 will be discussed in greater detail in the description of FIG. 2, below.

The central offices 30 and 32 are facilities which provide services for switching voice and data traffic for communication to wireline devices shown as telephones 60, 62, 64, 66 and caller identification (“caller ID”) box 68 in the communications network 2 over standard telephone (i.e., POTS) lines. The MSC 34 is a facility which is utilized to communicate wireless voice and data traffic to wireless devices 52, 54, and 56 via tower 50. It will be appreciated by those skilled in the art that the wireless devices 52, 54, and 56 may include, but are not limited to, cellular telephones, two-way paging devices, personal digital assistants (“PDAs”), handheld computers, and the like. It will further be appreciated that the tower 50 may be configured to communicate cellular signals compatible with conventional cellular telephone networks as well as wireless signals utilizing protocols compatible with other wireless networks known to those skilled in the art.

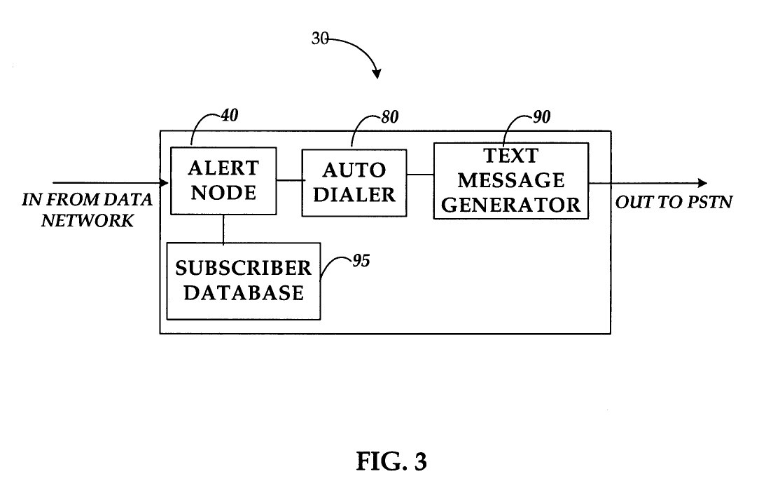

Those skilled in the art will further appreciate that the MSC 34 may also be connected to a wireline network for communicating wireless voice and data traffic over the PSTN. The central offices 30 and 32 as well as the MSC 34 include alert nodes 40, 42, and 44, respectively. In the communications network 2, the alert nodes 40, 42, and 44 receive data messages from the monitoring station 20 and communicate emergency alerts contained in the data messages to the wireline devices 60, 62, 64, 66, and 68 as well as to the wireless devices 52, 54, and 56. It will be appreciated by those skilled in the art, that in one illustrative embodiment, the alert nodes 40, 42, and 44 may serve as routing points in the data network 2. The routing points may be circuit switches, softswitches, media gateways, or other data routers for routing voice and data traffic in the communications network 2. The alert nodes 30, 32, and 34 will be described in greater detail in the description of FIG. 3, below.

The data network 25 provides a medium for communicating data messages between the monitoring station 20 and the alert nodes 40, 42, and 44 as well as the personal computer 70. It should be appreciated that the data network 25 may comprise a wide area network such as the Internet. The Internet is well known to those skilled in the art as essentially a packed-switched network based on the family of protocols called Transmission Control Protocol/Internet Protocol (“TCP/IP”), a family of networking protocols providing communication across interconnected networks between computers with diverse architectures and between various computer operating systems. Data messages communicated in these networks are communicated as Internet protocol (“IP”) datagrams or packets. The operation of the Internet and the TCP/IP transmission protocols is well known to those skilled in the art. Those skilled in the art will also appreciate that the data network 25 is not limited to the Internet and but may encompass a variety of other wireless and wireline networks as well including, but not limited to, local area networks, virtual private networks (“VPNs”), cable networks, broadcast networks, multicast networks (including wirleless multicast IP networks), and the PSTN.

The personal computer 70 communicates data with the monitoring station 20 over the data network 25. Those skilled in the art will appreciate that the embodiments of the invention are not limited to the personal computer 70, but may be practiced with other communications devices including voice over Internet protocol (“VoIP”) or Internet telephones, microprocessor-based or programmable consumer electronics, minicomputers, mainframe computers, and the like.

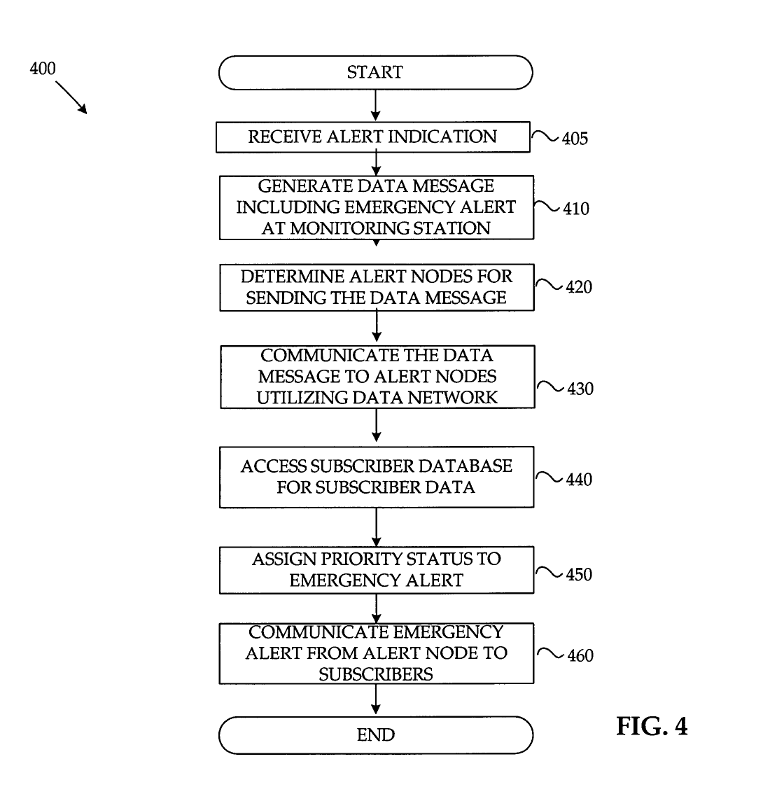

Referring now to FIG. 2, the monitoring station 20 will now be described in greater detail. As shown in FIG. 2, the monitoring station 20 may comprise a general-purpose computer system including a central processing unit 104 (“CPU”), a system memory 106, including a random access memory 108 (“RAM”) and a read-only memory (“ROM”) 110, and a system bus 112 that couples the memory 106 to the CPU 104. A basic input/output system (“BIOS”) containing the basic routines that help to transfer information between elements within the computer, such as during startup, is stored in the ROM 110. The monitoring station 20 further includes a mass storage device 114 for storing an operating system 116 and application programs 126. The application programs 126 may be used to generate data messages 136 containing emergency alert information to be communicated to the alert nodes 40, 42, and 44, as will be described in greater detail below in the discussion of FIG. 4.

The mass storage device 114 is connected to the CPU 104 through a mass storage controller (not shown) connected to the bus 112. The mass storage device 114 and its associated computer-readable media, provide non-volatile storage for the monitoring station 20. Although the description of computer-readable media contained herein refers to a mass storage device, such as a hard disk or CD-ROM drive, it should be appreciated by those skilled in the art that computer-readable media can be any available media that can be accessed by the CPU 104.

The monitoring station 20 may also include input/output controller interfaces 122 for receiving and processing input from a number of devices, including a keyboard or mouse (not shown). Similarly, the input/output controller interfaces 122 may provide output to a display screen, printer, or other type of output device. The monitoring station 20 may connect to the data network 25 via a network interface unit 124 connected to the bus 112. It should be appreciated that the network interface unit 124 may also be utilized to connect to other types of networks and remote computer systems, including other monitoring stations.

Referring now to FIG. 3, the central office 30, which encompasses the alert node 40, will now be described in greater detail. The central office 30 includes the alert node 40 for receiving data messages (such as IP messages) from the monitoring station 20 over the data network 25, and for communicating emergency alerts contained in the data messages to the telephones 60 and 62 over the PSTN. The alert node 40 is in communication with an autodialer 80, a text message generator 90, and a subscriber database 95.

As briefly discussed above, the alert node 40 may be a softswitch for routing voice and data traffic in a communications network. As is known to those skilled in the art, a softswitch (also known as a software switch) is a software-based switching platform utilized to link PSTN and IP networks and manage traffic which may contain a mixture of voice, fax, data and video. Softswitches are capable of processing the signaling for all types of packet protocols (including IP and ATM) and support multiple quality of service (“QoS”) levels for communications. In the central office 30, the softswitch may be utilized to receive IP data traffic containing emergency alerts from the monitoring station 20 over the data network 25 and (where necessary) convert the data traffic to PSTN traffic containing the emergency alert for communication to the telephones 60 and 62.

The alert node 40 may utilize the autodialer 80 to automatically dial the involved (in the alert) subscriber telephone numbers stored in the subscriber database 95 to communicate emergency alerts. Autodialers are well known to those skilled in the art. In one illustrative embodiment, the alert node 40 may also use the text message generator 90 to send the emergency alert as a text message compatible with a caller identification device which may be attached to the telephones 60 and 62. Text message generators such as the one described above are well known to those skilled in the art.

It will be appreciated that other alert nodes in the communications network 2 may perform similar functions as the alert node 40 over networks other than the PSTN. For example, the alert node 44 may be a mobile switch configured to receive an IP data message containing an emergency alert from the monitoring station 20 over the data network 25 and to communicate the emergency alert via the cellular tower 50 to cellular network subscribers at wireless devices 52, 54, and 56. In one illustrative embodiment, the alert node 44 may be configured as a Short Message Service Center (SMSC) for communicating emergency alerts as SMS messages to compatible wireless devices. The communication of SMS messages in a communications network is well known to those skilled in the art. In still another illustrative embodiment, the alert node 40 may be a broadcast message center for communicating broadcast messages to multiple recipients over the data network 25. In still another illustrative embodiment, the alert node 40 may be configured to communicate multicast messages to selected groups of recipients over the data network 25.

Referring now to FIG. 4, an illustrative routine 400 will be described illustrating a process for utilizing the data network 25 described in the network architecture of FIG. 1, according to one illustrative embodiment of the invention. The routine 400 begins at operation 405 where an alert indication is received at the monitoring station 20. From operation 405, the routine 400 continues to operation 410, where a data message including an emergency alert is generated at the monitoring station 20. In particular, the emergency alert may be included in an IP data message for communication over the data network 25.

From operation 410, the routine 400 continues to operation 420 where the monitoring station 20 determines alert nodes for sending the data message containing the emergency alert. For instance, the emergency alert may include information such as a specific geographic area affected by an impending or ongoing emergency. Based on the alert information, the monitoring station 20 may determine (through manual or automatic means) the location of central offices and mobile switching centers containing alert nodes in the affected geographic area.

From operation 420, the routine 400 continues to operation 430 where the monitoring station 20 communicates the data message containing the alert information to the alert nodes identified in operation 420 utilizing the data network 25. For instance, if the emergency alert indicates a geographic area including the central office 30, the data message is sent to the alert node 40 via the data network 25.

From operation 430, the routine 400 continues to operation 440 where the alert node receives the data message and accesses the subscriber database 95 for subscriber data such as telephone numbers. In particular, upon receiving the data message from the monitoring station, the alert node (as discussed above with respect to FIG. 3) may be utilized to convert the data message into a PSTN or cellular network compatible signal for communication to subscribers over telephone lines or a cellular network. As discussed above with respect to FIG. 3, the autodialer 80 may be utilized to generate telephone calls to several subscribers at once prior to communicating the alert. It should be understood that in one illustrative embodiment, the function of identifying the telephone numbers to be dialed may also be performed by the monitoring station 20. The telephone numbers may be included in the data message sent from the monitoring station 20 to the alert nodes 40 and 42.

From operation 440, the routine 400 continues to operation 450 where the alert node assigns priority status to the emergency alert. In particular, the alert node may be configured to prioritize alert messages ahead of other non-emergency calls which may be pending but not yet established with subscribers. From operation 450, the routine 400 continues to operation 460 where the alert node communicates the emergency alert to the applicable subscribers. It will be appreciated that in the various illustrative embodiments of the invention, the emergency alert may be communicated from the alert node in the PSTN as a multicast or broadcast voice announcement, text message which may be received by a compatible caller ID device, or data message. In a cellular network, the emergency alert may be communicated from the alert node as a voice announcement or a text message (such as an SMS message). The emergency alert may also be communicated as an electronic mail (“e-mail”) message over either the PSTN or cellular network if subscriber e-mail addresses are available. From operation 460, the routine 400 then ends.

Based on the foregoing, it should be appreciated that the various embodiments of the invention include methods and systems for utilizing a data network for the communication of emergency alerts. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for utilizing a data network for the communication of an emergency alert, comprising:
receiving an alert indication;
in response to receiving the alert indication, generating a data message comprising the emergency alert;
determining at least one destination for communicating the data message; and
communicating the data message over the data network to the at least one destination.

2. The method of claim 1 further comprising:
accessing a subscriber database at the at least one destination; and
communicating the emergency alert in the data message from the at least one destination to a plurality of the subscribers in the subscriber database.

3. The method of claim 1 further comprising forwarding the data message to a plurality of devices in the data network.

4. The method of claim 1, wherein receiving the alert indication comprises receiving the alert indication which has geographical information

5. The method of claim 1, wherein determining at least one destination for communicating the data message comprises determining at least one alert node for communicating the data message.

6. The method of claim 5, wherein determining at least one alert node for communicating the data message comprises determining at least one routing point in the data network for communicating the data message.

7. The method of claim 5, wherein communicating the data message over the data network to the at least one destination comprises communicating the data message to the at least one alert node, wherein the at least one alert node comprises a mobile switching center in a wireless network.

8. The method of claim 1, wherein communicating a data message over the data network comprises communicating an Internet protocol message over the data network.

9. The method of claim 1, wherein communicating a data message over the data network comprises communicating a short message service message over the data network.

10. The method of claim 1, wherein communicating a data message over the data network comprises communicating a plain old telephone system (POTS) signal over the data network.

11. The method of claim 1, wherein communicating a data message over a data network comprises communicating a message compatible with a caller identification device.

12. The method of claim 1, wherein communicating a data message over a data network comprises communicating a broadcast message over the data network.

13. The method of claim 1 further comprising prioritizing the communication of the emergency alert in the data message.

14. A system for utilizing a data network for the communication of emergency alerts, comprising:
a monitoring station for generating a data message comprising an emergency alert; and
at least one alert node for receiving the data message from the monitoring station over the data network and communicating the emergency alert in the data message to at least one communications device.

15. The system of claim 14, wherein the at least one alert node is in communication with a subscriber database and an autodialer for communicating the emergency alert to subscribers in the subscriber database.

16. The system of claim 14 further comprising a text message generator for generating a text message compatible with a caller identification device.

17. The system of claim 14, wherein the alert node is operative to prioritize the communication of the emergency alert in the data message.

18. The system of claim 14, wherein the alert node is operative to forward the data message to a plurality of devices in the data network.

19. The system of claim 14, wherein the alert node is a routing point in the data network.

20. The system of claim 14, wherein the alert node is operative to communicate the emergency alert as a broadcast message.
